(19) United States
(12) Patent Application Publication
(10) Pub. No.: US 2026/0181413 A1
(43) Pub. Date: Jun. 25, 2026

(54) Implementing Energy Savings in a Cellular Communication Network

(71) Applicant: Rakuten Mobile, Inc, Tokyo (JP)

(72) Inventor: Kexuan Sun, Weybridge (GB)

(21) Appl. No.: 18/837,393

(22) PCT Filed: Jul. 25, 2024
(86) PCT No.: PCT/US2024/039544

§ 371 Date: Aug. 9, 2024

Related U.S. Application Data
(60) Provisional application No. 63/582,672, filed on Sep. 14, 2023.

(51) Int. Cl. H04W 24/02; H04W 16/14; H04W 72/54

(52) U.S. Cl. CPC H04W 24/02; H04W 16/14; H04W 72/54

(57) ABSTRACT

A cellular communication network includes a plurality of antennas. A plurality of radio units are coupled to the plurality of antennas and configured to input analog signals to the plurality of antennas. One or more distributed units coupled to the plurality of radio units and configured to control operation of the plurality of radio units. One or more central units are coupled to the one or more distributed units. A near real time radio access network (RAN) intelligent controller (RIC) coupled to at least one of the one or more distributed units or the one or more central units by way of one or more E2 interfaces, the near real time RIC configured to invoke execution or enforcement of energy saving controls or policies by the at least one of the one or more distributed units or the one or more central units over the one or more E2 interfaces.

### CROSS-REFERENCE TO RELATED APPLICATION

This application claims priority to U.S. Provisional Application Ser. No. 63/582,672 filed Sep. 14, 2023; the entire contents of which are incorporated herein by reference.

### FIELD

This invention relates to implementing energy savings in a cellular communication network.

### BACKGROUND

The information disclosed in this background section is only for enhancement of understanding of the general background of the disclosure and should not be taken as an acknowledgement or any form of suggestion that this information forms the prior art already known to a person skilled in the art.

Cellular communication networks convert electrical current into radio waves conveying information to mobile devices (“user equipment”). For a large communication network, this requires a large amount of electrical power. It would be an advancement in the art to improve energy utilization in a cellular communication network.

### SUMMARY

In one aspect, a cellular communication network includes a plurality of antennas. A plurality of radio units are coupled to the plurality of antennas and configured to input analog signals to the plurality of antennas. One or more distributed units coupled to the plurality of radio units and configured to control operation of the plurality of radio units. One or more central units are coupled to the one or more distributed units. A near real time radio access network (RAN) intelligent controller (RIC) coupled to at least one of the one or more distributed units or the one or more central units by way of one or more E2 interfaces, the near real time RIC configured to invoke execution or enforcement of energy saving controls or policies by the at least one of the one or more distributed units or the one or more central units over the one or more E2 interfaces.

### BRIEF DESCRIPTION OF THE DRAWINGS

Features, aspects, and advantages of embodiments of the disclosure will be described below with reference to the accompanying drawings, in which like reference numerals denote like elements, and wherein:

FIG. 1 is a schematic block diagram of a cellular communication network in which energy saving may be performed in accordance with an embodiment;

FIG. 2 is a schematic diagram illustrating an architecture for implementing energy savings in accordance with an embodiment;

FIG. 3 is a process flow diagram of a method for implementing energy savings in a cellular communication network in accordance with an embodiment; and

FIG. 4 is a schematic block diagram of an example computing device suitable for implementing methods in accordance with an embodiment.

### DETAILED DESCRIPTION

The following detailed description of example embodiments refers to the accompanying drawings. The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, the flowchart and description of operations provided below relate to one of the various embodiments. It should be noted that it is possible to make other embodiments that do not exactly match the flowchart and its description. It is understood that in other embodiments one or more operations may be omitted, one or more operations may be added, one or more operations may be performed simultaneously (at least in part).

It will be apparent that systems and/or methods, described herein, may be implemented in different forms of hardware, software, or a combination of hardware and software. The actual specialized control hardware or software code used to implement these systems and/or methods is not limiting of the implementations. Thus, the operation and behavior of the systems and/or methods are described herein without reference to specific software code. It is understood that software and hardware may be designed to implement the systems and/or methods based on the description herein.

Even though particular combinations of features are recited in the claims and/or disclosed in the specification, these combinations are not intended to limit the disclosure of implementations. In fact, many of these features may be combined in ways not specifically recited in the claims and/or disclosed in the specification. Although each dependent claim listed below may directly depend on only one claim, the disclosure of implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B],” “[A] and/or [B],” or “at least one of [A] or [B]” are to be understood as including only A, only B, or both A and B.

The foregoing disclosure provides illustration and description but is not intended to be exhaustive or to limit the implementations to the precise form disclosed. Modifications and variations are possible in light of the above disclosure or may be acquired from practice of the implementations.

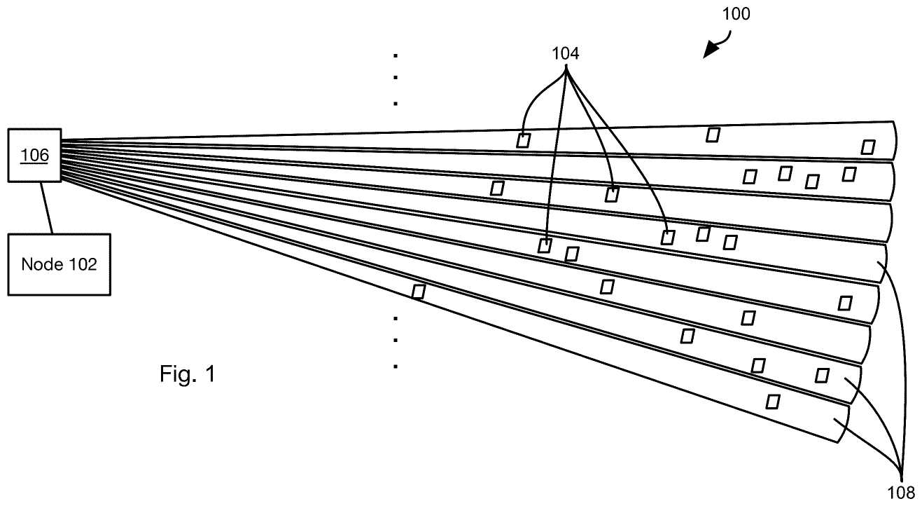

FIG. 1 illustrates an example cellular communication network 100 in which a node 102 establishes radio connections to a plurality of items of user equipment (UE) 104. The node 102 may be a computing device configured to manage radio communication, such as a gNodeB or eNodeB. Each UE 104 may be implemented as a mobile phone or other device capable of cellular radio communication with the node 102. The node 102 may use a beam-forming antenna 106, such as a millimeter wave analog beam-forming antenna. There may be any number of nodes 102 and antennas 106 in the cellular communication network. The beam-forming antenna 106 may define a plurality of discrete directions 108 along which the beam-forming antenna 106 may direct a beam. Each direction 108 may have a corresponding index, such as a synchronization signal block (SSB) index according to the fifth generation/new radio (5G/NR) standard. When the beam from the beam-forming antenna 106 is directed along a particular direction, a certain number of UEs 104 will be located within the angular extent and range of the beam such that the UE 104. As used herein a UE 104 is “within” a direction 108 when the UE 104 is able to have an active radio connection to the beam-forming antenna 106 when the beam is directed in the direction 108. The manner in which a UE 104 is determined by the node 102 to be located within a given direction 108 may be performed using any approach known in the art. Each direction 108 may correspond to a “cell” in the cellular communication network 100 that has an associated identifier and that can be allocated for use for communication with a UE 104.

The node 102 may communicate simultaneously with multiple UEs 104 by allocating one or more frequency channels to each UE 104 located in a given direction 108. Each UE 104 located in a direction 108 may be assigned a slot representing one or more frequency bands, and a time slot, e.g., 0.5 seconds. For example, each slot may be a physical resource block (PRB) according to the 5G/NR standard. Within a slot assigned to a UE, the node 102 transmits data to the UE 104, such as packets including voice data or network communication data.

The cellular communication network 100 or other implementations of a cellular communication network may implement an open radio access network (O-RAN). The O-RAN may be as published by the O-RAN alliance in the following documents, all of which are incorporated by reference herein by reference in their entirety:
O-RAN Architecture Description 9.0, O-RAN.WG1.OAD-R003-v09.00 (June 2023),
O-RAN Slicing Architecture 10.0, O-RAN.WG1.Slicing-Architecture-R003-v10.00 (June 2023).
O-RAN Use Cases Analysis Report 11.0, O-RAN.WG1.Use-Cases-Analysis-Report-R003-v11.00 (June 2023).
O-RAN Use Cases Detailed Specification 11.0, O-RAN.WG1.Use-Cases-Detailed-Specification-R003-v11.00 (June 2023).
O-RAN Network Energy Saving Use Cases Technical Report 2.0, O-RAN.WG1.Network-Energy-Savings-Technical-Report-R003-v02.00 (June 2023).
O-RAN RI interface: Use Cases and Requirements 4.0, O-RAN.WG2.RIUCR.v04.00 (June 2023).
O-RAN Massive MIMO Use Cases Technical Report 1.0, O-RAN.WG1.mMIMO-Use-Cases-TR-v01.00 (June 2022).

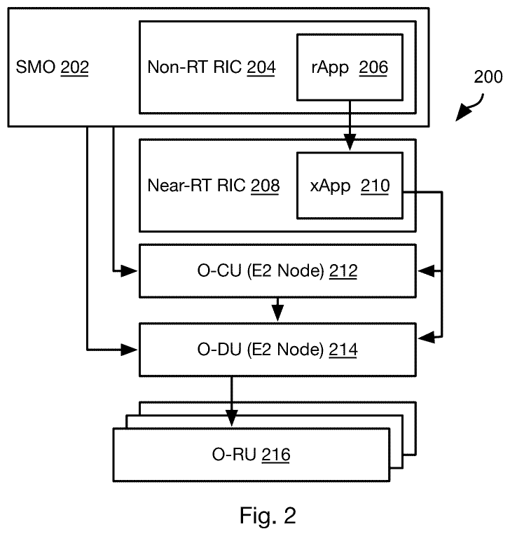

Referring to FIG. 2, the illustrated architecture 200 may be used to improve energy utilization in a cellular communication network 100. In particular, the illustrated architecture 200 may be used to identify periods of time in which a frequency band, a direction 108, or entire antenna 106 is not in use and, in response, reduce the amount of energy expended in that frequency band or direction 108 or by the entire antenna 106.

The architecture 200 includes an orchestrator 202, such as a service management and orchestration (SMO) orchestrator according to the O-RAN standard. The orchestrator 202 may execute a non-real time radio intelligent controller (Non-RT RIC) 204, which may also be implemented according to the O-RAN standard.

The orchestrator 202, such as the non-RT RIC 204 executed by the orchestrator 202, may execute custom applications (e.g. rApp 206). The rApp 206 may be configured to receive configurations from an operator to control parameters used to implement energy savings. For example, the rApp 206 may define an interface for receiving quality of service (QoS) and energy saving requirements. The rApp 206 may further define an interface for receiving advanced sleep mode (ASM) parameters and radio frequency (RF) channel reconfiguration controls.

The rApp 206 may use inputs received in order to configure a custom application executing in a near-RT RIC 208, such as the illustrated xApp 210. For example, there may be a plurality of near-RT RIC 208 in a cellular communication network 100 and the rApp 206 may distribute some or all of the QoS requirements, energy saving requirements, ASM parameters, and radio frequency (RF) channel reconfiguration controls to the xApps 210 of one or more near-RT RIC 208.

The xApp 210 may be coupled to one or more O-RAN central units (O-CU) 212 and one or more O-RAN distributed units (O-DU) 214. The O-CU 212 may likewise be connected to the one or more O-DU 214 and control the operation of the O-DU 214. The O-CU 212 and O-DU 214 may be implemented as O-CU and O-DU, respectively, according to the O-RAN standard. The xApp 210 may communicate with each O-CU 212 and O-DU 214 using an E2 interface as defined by the O-RAN standard. In particular, each O-CU 212 and O-DU 214 may be an E2 node according to the O-RAN standard.

Each O-DU 214 may be coupled to one or more radio units (RU) 216, such as an O-RU according to the O-RAN standard. Each O-RU 216 may be a computing device configured to manage radio communication, such as converting data into analog signals transmitted to an antenna 106. For example, the O-RU 216 may be a gNodeB or eNodeB. For example, the O-RU 216 may be a node 102 as described above.

As shown in FIG. 2, the orchestrator 202 may additionally be directly connected to each O-CU 212 and O-DU 214 in order to configure each O-CU 212 and O-DU 214. However, real-time instructions to the O-CU 212 and O-DU 214 may be generated by the xApp 210.

O-RAN has already identified several use cases and solutions for energy saving (ES) optimization which includes cell switching (off/on), radio frequency (RF) channel reconfigurations, and advanced sleep mode (ASM). However, the architecture 200 and associated control interface design for energy saving optimization based on RF channel reconfiguration and ASM using the near-RT RIC 208 as disclosed herein has not been implemented in prior approaches.

The architecture 200 uses the E2 interface (i.e., an open interface between two endpoints in an O-RAN network) to improve the O-RAN network energy efficiency based on advanced artificial intelligence and/or machine learning (AI/ML) solutions in the near-RT RIC 208. The approach described herein provides an end-to-end architecture solution around the E2 interface which enables network energy savings by the near-RT RIC 208 that can provide significant gain thanks to the more UE centric, near real-time intelligent control capabilities with the near-RT RIC 208. The approach described herein creates several new E2 controls, policy services styles and configuration attributes that enable xApps to (1) intelligently steer user traffic to create more opportunities for saving energy by reducing number of RF channels or trigger ASM sleeping periods and (2) provide policy requirement or guidance to the O-DU 214 and O-CU 212 to trigger reconfiguration of an RF channel and ASM in near real-time. The CUs 212 may be communicating devices implementing the cellular communication network 100 or located in a data network. The DUs 214 may be in a data network or other network and may have connections to other networks, such as the Internet.

An E2E (endpoint-to-endpoint) architecture solution including functional responsibilities in each E2 node in the architecture, and E2 control/configuration attributes are also disclosed.

The approach described herein enables network energy saving optimization by the near-RT RIC 208 with custom xApps 210 based on advanced AI/ML technologies that can provide significant gain to the energy efficiency of the cellular communication network 100 thanks to the more UE centric, near real-time intelligent control capabilities with the near-RT RIC 208. This greatly reduce the energy related operating expenses for the operators. The improvement to energy efficiency is also critical for reducing CO₂ emissions which make energy saving a strategic goal for network operators.

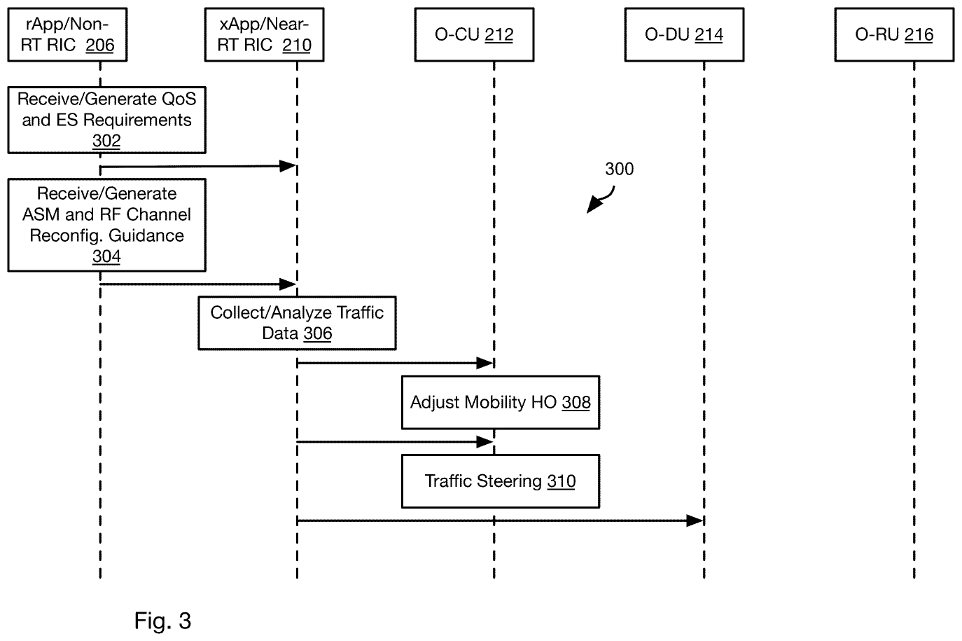

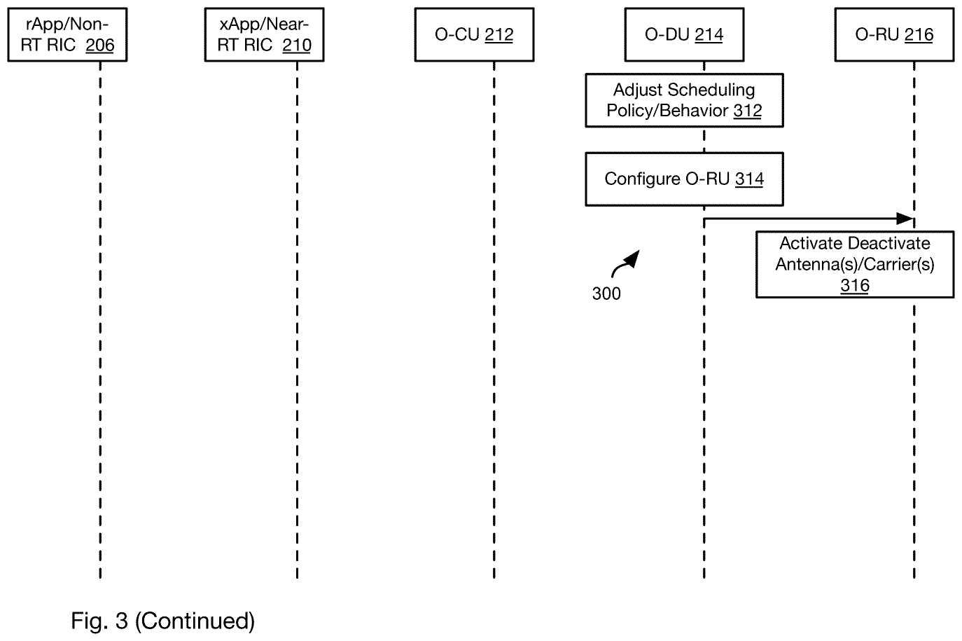

FIG. 3 illustrates a method 300 that may be performed using the architecture 200.

The illustrated distribution of functions among the illustrated components is exemplary only and other distributions may also be implemented.

The method 300 may include receiving (such as from operators or vendors) or generating 302, by the rApp/Non-RT RIC 206, quality of service (QoS) and energy saving (ES) requirements, and pass the requirements from the rApp/Non-RT RIC 206 to xApps/Near-RT RIC 210, such as via the O1 or A1 interface. The method 300 may further include receiving or generating 304, by the rApp/Non-RT RIC 206, one or both of advanced sleep mode (ASM) guidance and radio frequency (RF) reconfiguration guidance and pass the information to the xApps/Near-RT RIC 210 via the O1 or A1 interface. For example, the ASM guidance may specify a number of UE connections 104, an amount of traffic from connected UEs 104, or other criteria used to determine when the associated O-RU carrier 216 may be placed in a low energy state, e.g. sleeping for a certain period of time (several symbols or slots) in between two successive synchronization signal block (SSB) and System Information Block (SIB) transmissions. The RF reconfiguration guidance may specify criteria (a number of UE connections 104, an amount of traffic from connected UEs 104, or other criteria) for a particular frequency band and/or direction 108 for which certain portion of O-RU RF channels/array elements transmission/receiving in that frequency band and/or direction 108 may be omitted.

The xApp/Near-RT RIC 210 may collect 306 traffic data for a plurality of cells, such as the number of UE 104 connected to each cell, the number of UE 104 in each cell that cannot be handed off to another cell (i.e., not simultaneously in another cell), and/or an amount of data being transmitted within each cell (e.g., number of utilized physical resource blocks (PRBs)).

Step 306 may further include analyzing the traffic data. For example, the traffic data may be analyzed according to an artificial intelligence (AI) or machine learning (ML) model (AI/ML). For example, and AI/ML model may be trained to identify, for a given set of traffic data for a plurality of cells, a configuration having a lower energy consumption, the configuration being defined as pairings of UE 104 represented in the traffic data to cells within which the UE 104 are present.

The AI/ML model may be trained with human or automatically generated training data. For example, a human operator or algorithm may identify, for a given set of traffic data a consolidation of UE 104 such that the same UE 104 are connected to a reduced number of cells, a reduced number of antennas, and/or a reduced number of radio units 216 as compared to the connections to the UE 104 indicated in the traffic data, and an estimate of energy savings achieved through the consolidation. The set of traffic data and the consolidation may then be used as a training data entry along with many (e.g., thousands of) other training data entries to train a machine learning model to propose a consolidation of connections for a given set of traffic data.

The xApp/Near-RT RIC 210 may invoke the performance of actions by the O-CU 212 using the E2 interface. For example, the xApp 210 may cause the O-CU 212 to adjust 308 mobility handovers (HO) for one or more UEs 104. For example, the O-CU 212 may promote handing over of connections away from some cells and promote handing over of connections to other cells in order to adjust loading conditions of different cells before optimizing the cells based on ASM or RF Channel Reconfiguration techniques.

The xApp/Near-RT RIC 210 may invoke the O-CU 212 to perform traffic steering 310 based on the traffic data and/or analysis from step 306. For example, the O-CU 212 may steer traffic from UEs 104 to specific cells in order to achieve the QoS requirement while creating opportunities for reducing energy consumption within frequency bands or directions 108, O-RU based on ASM or RF channel reconfiguration techniques. For example, traffic steering 310 may be used to steer traffic from UEs 104 to specific cells to adjust traffic conditions of the UEs on different cells before optimizing the cells based on ASM or RF Channel Reconfiguration techniques

The xApp/Near-RT RIC 210 may invoke one or more DUs 214 to adjust 312 the scheduling policies and/or behaviors of the one or more DUs 214. For example, there may be a plurality of energy saving (ES) levels 0 to n, where n is an integer greater than 1, that are supported by an E2 node, such as an O-DU 214. Each ES level may have an associated vendor-specific proprietary scheduling algorithm that may not be standardized. An AI/ML model for ES optimization may trained using data and measurements related to each ES level to select an ES level for a given set of data, such as the traffic data collected at step 306. The AI/ML model may be processing by the near real time RIC. The trained AI/ML model may, based on collected data, select an ES level. For example, ES level 0 may provide no ES optimization (e.g., provide maximum performance as compared to the other ES levels). Higher index ES levels provide more aggressive ES optimization depending on the vendor specific implementation of each ES level.

The method 300 may include the xApp/Near-RT RIC 210214 guiding 312 O-DU's traffic scheduling policy and/or scheduling behaviors. Guiding 304 traffic scheduling behaviors may include the functionality described with respect to FIGS. 3A and 3B, e.g., changing an amount of transmission/receiving slots per antenna or per O-RU carrier in a frequency band between two successive transmissions of SS/RS blocks. Transmission or receiving blank periods are created for putting the RF channel/antenna element or O-RU carrier into sleep. O-RU

Steps 312 and 314 may be performed by the O-DU 214 in response to instructions from the xApp/Near-RT RIC 210. For example, the xApp/Near-RT RIC 210 may transmit messages to each O-DU 214 in order to send the commands or policies, such as over the E2 interface or some other interface. Examples of such control commands or policies, and the corresponding control or policy message IE parameters or attributes that may be included are described in detail below. The O-DU 214 may then configure or control 314 O-RU 216 according to the command or policy received from the xApp/Near-RT RIC to create the transmission or receiving blank periods as described above.

At step 316, the O-RU 216 may then activate and deactivate one or more RF channels/antennas or the entire O-RU carrier 106 according to the configuration/command of step 314. In particular the O-RU 216 may, according to the configuration/command of step 314, deactivate the transmission or receiving in a frequency band for one or more symbols or slots in the data direction (DL/UL) as indicated in the configuration/command of step 314,

As shown in FIGS. 2 and 3, the E2 interface may function as a control interface that enables xApps 210 and Near-RT RIC to impact the E2 node behaviors (e.g., behaviors of the O-CU 212 and/or O-DU 214) to save energy. The impact can be made by directly send control commands to the E2 node or via policy. E2 policy or control actions includes:

Type 1: Evolved Universal Mobile Telecommunications System (UMTS) Terrestrial Radio Access New Radio Network (E-UTRAN-NR) Dual Connectivity, Carrier Aggregation, connected mode mobility, idle mode mobility and radio access controls to steering UE traffic from on cell to another in order to create more sleeping opportunities for the cell while maintaining acceptable QoS for the UEs 104 potentially being affected.

Type 2: Guide cell and UE discontinuous transmission (DTX) and discontinuous reception (DRX) configurations as well as common channel configurations (e.g. SSB, channel state information reference signal (CSI-RS)) to create more deep sleep opportunities.

Type 3: O-DU & O-CU policy control to tweak a cell between aggressive power saving mode (of O-RU or Cloud NF) and maximum performance mode to balance the performance and energy consumption of the cell.

Type 4: Guide O-DU to configure certain O-RU RF channels of a carrier/cell (RF channel reconfiguration) or the entire carrier/cell (ASM) into sleep mode via open radio access network front haul (O-FH_control (C)-plane or management (M)-plane for certain slots or symbols following a periodic pattern, or for a long period of continuous sleeping (deep sleep) interval.

Type 5: Guide the configuration of array patterns (number of antenna elements and antenna layouts), multiple input multiple output (MIMO) layers and maybe precoding matrixes etc, for improved energy efficiency, service coverage and performance during sleep periods.

Type 6: Near-RT RIC 208 may also provide performance and energy efficiency or energy consumption targets for cells, carrier (e.g., cells allocated to a particular carrier), O-RU, and geographic area (e.g., cells within a geographic area).

In one solution, for control/policy type 1 above, the existing E2SM-RC features for traffic steering and QoS/QoE optimization can be used. For control/policy type 2 above, the existing E2 service management cell configuration and control (E2SM-CCC) RAN Configuration Structure, O-NRCellDU, and the E2SM-CCC CONTROL Service Style Type 2 can be reused. For control/policy type 3 above, a new RAN configuration structure can be defined in the E2SM-CCC specification, referred to herein as “O-NESPolicy,” which may reuse E2SM-CCC CONTROL Service Style Type 2 for cell level configuration and control.

Table 1 lists RAN configuration structures according to the O-RAN standard that may be modified to implement energy saving. The definitions referenced in Table 1 are hereby incorporated herein by reference in their entirety.

TABLE 1
O-RAN Standard Configuration Structures.

| | RAN | |
|---|---|---|
| | Config- | |
| RAN | uration | |
| Configuration | Structure | Semantics |
| Structure Name | Definition | Description |
| O-NRCellCU | 8.8.2.1 | Represents O- |
| | | NRCellCU attributes |
| | | defined in 8.8.2.1. |
| O-NRCellDU | 8.8.2.2 | Represents |
| | | O-NRCellDU |
| | | attributes defined |
| | | in 8.8.2.2. |
| O-BWP | 8.8.2.3 | Represents |
| | | O-BWP attributes |
| | | defined in 8.8.2.3. |
| O- | 8.8.2.4 | Represents |
| RRMPolicyRatio | | O-RRMPolicyRatio |
| | | attributes defined |
| | | in 8.8.2.4. |
| O-NESPolicy | See below | Represents |
| | | O-NESPolicy |
| | | attributes defined |
| | | below |

The attributes in O-NESPolicy required for the O-DU scheduler policy control are listed below with descriptions of the purpose of the attributes. Table 2 lists information elements (IE) and corresponding descriptions that may be used to perform scheduler policy control.

TABLE 2
Information Elements for Scheduler Policy Control.

| | | Is | | |
|---|---|---|---|---|
| IE/ | Supported | writ- | IE type and | Semantics |
| Group Name | Services | able | reference | description |
| energySavingState | REPORT, | TRUE | ENUMERATED | Specifies the status |
| _ASM | CONTORL | | (None, | regarding the energy |
| | | | isNotEnergySaving, | saving in the cell. |
| | | | isEnergySaving) | If the value of |
| | | | | energySavingControl_A |
| | | | | SM is |
| | | | | toBeEnergySaving, then |
| | | | | it shall be tried to |
| | | | | achieve the value |
| | | | | isEnergySaving for the |
| | | | | energySavingState_ASM. |
| | | | | If the value of |
| | | | | energySavingControl_A |
| | | | | SM is |
| | | | | toBeNotEnergySaving, |
| | | | | then it shall be tried to |
| | | | | achieve the value |
| | | | | isNotEnergySaving for the |
| | | | | energySavingState_ASM. |
| energySavingControl | REPORT, | TRUE | ENUMERATED | To initiate ASM |
| _ASM | CONTORL | | (None, | optimization activation |
| | | | toBeEnergySaving, | or deactivation. |
| | | | toBeNotEnergySaving) | |
| energySavingState | REPORT, | TRUE | ENUMERATED | Specifies the status |
| _trxControl | CONTORL | | (None, | regarding the energy |
| | | | isNotEnergySaving, | saving in the cell. |
| | | | isEnergySaving) | If the value of |
| | | | | energySavingControl_ |
| | | | | trxControl is |
| | | | | toBeEnergySaving, then |
| | | | | it shall be tried to |
| | | | | achieve the value |
| | | | | isEnergySaving for the |
| | | | | energySavingState |
| | | | | _trxControl. |
| | | | | If the value of |
| | | | | energySavingControl_ |
| | | | | trxControl is |
| | | | | toBeNotEnergySaving, |
| | | | | then it shall be tried to |
| | | | | achieve the value |
| | | | | isNotEnergySaving for the |
| | | | | energySavingState |
| | | | | _trxControl. |
| energySavingControl | REPORT, | TRUE | ENUMERATED | To initiate RF channel |
| _trxControl | CONTORL | | (None, | reconfiguration |
| | | | toBeEnergySaving, | optimization activation |
| | | | toBeNotEnergySaving) | or deactivation. |
| energySavingPolicy | REPORT, | TRUE | INTEGER | Each ES level implies a |
| _ASM | CONTORL | | | vendor-specific |
| | | | | proprietary scheduling |
| | | | | algorithm that are not |
| | | | | standardized, for which |
| | | | | each E2 Node, who |
| | | | | supports the ES |
| | | | | optimization feature, |
| | | | | provides the number of |
| | | | | different policies |
| | | | | supported by its |
| | | | | scheduler indexed from |
| | | | | 1 to n. The AI/ML |
| | | | | model for ES |
| | | | | optimization is trained |
| | | | | by data and |
| | | | | measurements related to |
| | | | | each ES policy, for |
| | | | | which the trained |
| | | | | AI/ML model, based on |
| | | | | collected data, |
| | | | | configures the E2 Node |
| | | | | with an improved |
| | | | | inferred policy index to |
| | | | | be used. The Value = 0 |
| | | | | means no ES |
| | | | | optimization (maximum |
| | | | | performance) where |
| | | | | higher index value may |
| | | | | means more aggressive |
| | | | | ES optimization |
| | | | | depends on vendor |
| | | | | specific implementation. |
| energySavingPolicy | REPORT, | TRUE | INTEGER | Each ES level implies a |
| _trxControl | CONTORL | | | vendor-specific |
| | | | | proprietary scheduling |
| | | | | algorithm that are not |
| | | | | standardized, for which |
| | | | | each E2 Node, who |
| | | | | supports the ES |
| | | | | optimization feature, |
| | | | | provides the number of |
| | | | | different policies |
| | | | | supported by its |
| | | | | scheduler indexed from |
| | | | | 1 to n. The AI/ML |
| | | | | model for ES |
| | | | | optimization is trained |
| | | | | by data and |
| | | | | measurements related to |
| | | | | each ES policy, for |
| | | | | which the trained |
| | | | | AI/ML model, based on |
| | | | | collected data, |
| | | | | configures the E2 Node |
| | | | | with an improved |
| | | | | inferred policy index to |
| | | | | be used. The Value = 0 |
| | | | | means no ES |
| | | | | optimization (maximum |
| | | | | performance) where |
| | | | | higher index value may |
| | | | | means more aggressive |
| | | | | ES optimization |
| | | | | depends on vendor |
| | | | | specific implementation. |

For control/policy type 4-6 above, the same E2SM-CCC RAN Configuration Structure O-NESPolicy can be used as shown in Table 3. New attributes in O-NESPolicy required are listed below with descriptions of the purpose of the attributes.

TABLE 3
Information Elements for RAN Configuration.

| | | | IE | |
|---|---|---|---|---|
| IE/Group | Supported | Is | type and | Semantics |
| Name | Services | writable | reference | description |
| trxControl | REPORT, | TRUE | TrxControl | This configuration is defined to |
| | CONTORL | | (see below) | configure O-DU to energy saving |
| | | | | mode by disabling (″putting to |
| | | | | sleep″) some or all array |
| | | | | elements in a tx-array |
| | | | | or rx-array (or both). |
| | | | | In the configuration an antenna |
| | | | | mask is provided to indicate |
| | | | | which array elements are to be |
| | | | | put to sleep or woken up. |
| trxAntMask | REPORT, | TRUE | array | This command is to provide |
| | CONTROL | | (TrxAntMask) | pre-defined antenna masks to |
| | | | (see below) | the O-DU to define which |
| | | | | array elements are to be disabled |
| | | | | during sleep period decided |
| | | | | by theO-DU itself. |
| asm | REPORT | TRUE | Asm (see | This configuration is defined to |
| | CONTORL | | below) | configure O-DU to energy saving |
| | | | | mode by disabling (″putting to |
| | | | | sleep″) array carriers, tx-arrays |
| | | | | or rx-arrays or the whole O-RU. |
| | | | | When the command is issued it |
| | | | | pertains to all array elements in |
| | | | | the affected tx-array or rx-array. |

TABLE 4
Attributes for TRX Control (TrxControl <<datatype>>)

| Attribute name | Description |
|---|---|
| dataDirection | 1:DL or 0:UL |
| sleepMode | sleep mode |
| validDuration | duration for the configuration to |
| | be applied(>10 ms), 0 for |
| | indefinite sleep |
| symbolMask | symbol mask |
| antennaMask | antenna mask that masks out the |
| | antenna element to be disabled |
| antennaMaskName | ″antennaMaskName″ |
| | corresponds to the selected |
| | ″mask-name″ in the list, |
| | ″supported-trx-control-masks″, |
| | provided by O-RU, |
| dataLayerControl | Number of Data layer or Streams |
| | (e,g 1,2,4,16,32) |
| slotMask | ″slotMask″ contains an octet |
| | string mask value indicating the |
| | slot numbers in a frame (repeated |
| | sleep pattern every frame) for |
| | which the sleep mode |
| | configuration |
| | (antennaMaskName, |
| | antennaMask, sleepMode, |
| | dataDirection, symbolMask) to |
| | be applied. |
| | If absent, all slots except slots for |
| | common channel transmissions |
| | (e.g. SSB, SIB1, SIB2) are |
| | applied. |
| CHOICE EsObjective | |
| >targetEc | Target energy consumption, |
| | PEE.Energy (3GPP TS 28.552, |
| | clause 5.1.1.19.3), of O-RU in |
| | kWh. |
| >esPercentage | Energy consumption reduction of |
| | O-RU in percentage. The energy |
| | consumption is measured based |
| | on method defined in 3GPP TS |
| | 28.552, clause 5.1.1.19.3. |
| perfObjectiveList | |
| >perfObjective | |
| >> fiveQIValue | Indicate the corresponding |
| | service type for which the |
| | performance objective to be |
| | configured. |
| | See 3GPP TS 23.501, clause |
| | 5.7.4 and |
| | 3GPP TS28.541, clause 5.4 |
| >>maxbr | Maximum aggregated Flow Bit |
| | Rate for Non-GBR flows to limit |
| | the throughput of a Non-GBR |
| | service in order to create more |
| | sleep opportunities to save |
| | energy. |
| >>targePd | It indicates a preferred packet |
| | delay in average between O-DU |
| | F1U end point and UE (in unit of |
| | 0.5 ms) for a 5QI. The value shall |
| | be smaller than the E2E Packet |
| | Delay Budget configured in the |
| | QoS characteristics and smaller |
| | than maxPd if configured. |
| | O-DU can delay the traffic |
| | scheduling using the preferred |
| | delay, to concentrate the |
| | transmission in fewer number of |
| | slots, leaving transmission gaps |
| | to save energy through ASM |
| | (switching off O-RU RF |
| | components during the gaps). |

TABLE 5
Attributes for Transmission Antenna Mask
(TrxAntMask <<datatype>>)

| Attribute name | Description |
|---|---|
| arrayConfMode | Mode index of the array |
| | configuration (can be any number |
| | of different array configurations, |
| | e.g. for 2T 2R, 4T 4R, 16T 16R |
| | etc.) |
| dataDirection | 1:DL or 0:UL |
| numActiveAnt | Number of active antenna |
| | elements (e.g. 2,4,8,16,32) |
| antMask | antenna mask that masks out the |
| | antenna element to be disabled |
| | for the arrayConfMode |
| dataLayerControl | Number of Data layer or Streams |
| | (e,g 1,2,4,16,32) |

TABLE 6
Attributes for Advanced Sleep Mode (Asm <<datatype>>)

| Attribute name | Description |
|---|---|
| dataDirection | 1:DL or 0:UL |
| sleep Mode | sleep mode |
| validDuration | duration for the configuration to |
| | be applied(>10 ms), 0 for |
| | indefinite sleep |
| symbolMask | symbol mask |
| slotMask | ″slotMask″ contains an octet |
| | string mask value indicating the |
| | slot numbers in a frame (repeated |
| | sleep pattern every frame) for |
| | which the sleep mode |
| | configuration (sleepMode, |
| | dataDirection, symbolMask) to |
| | be applied. |
| | If absent, all slots except slots for |
| | common channel transmissions |
| | (e.g. SSB, SIB1, SIB2) are |
| | applied. |
| CHOICE EsObjective | |
| >targetEc | Target energy consumption, |
| | PEE.Energy (3GPP TS 28.552, |
| | clause 5.1.1.19.3), of O-RU in |
| | kWh. |
| >esPercentage | Energy consumption reduction of |
| | O-RU in percentage. The energy |
| | consumption is measured based |
| | on method defined in 3GPP TS |
| | 28.552, clause 5.1.1.19.3. |
| perfObjectiveList | |
| >perfObjective | |
| >> fiveQIValue | Indicate the corresponding |
| | service type for which the |
| | performance objective to be |
| | configured. |
| | See 3GPP TS 23.501, clause |
| | 5.7.4 and |
| | 3GPP TS28.541, clause 5.4 |
| >>maxbr | Maximum aggregated Flow Bit |
| | Rate for Non-GBR flows to limit |
| | the throughput of a Non-GBR |
| | service in order to create more |
| | sleep opportunities to save |
| | energy. |
| >>targePd | It indicates a preferred packet |
| | delay in average between O-DU |
| | F1U end point and UE (in unit of |
| | 0.5 ms) for a 5QI. The value shall |
| | be smaller than the E2E Packet |
| | Delay Budget configured in the |
| | QoS characteristics and smaller |
| | than maxPd if configured. |
| | O-DU can delay the traffic |
| | scheduling using the preferred |
| | delay, to concentrate the |
| | transmission in fewer number of |
| | slots, leaving transmission gaps |
| | to save energy through ASM |
| | (switching off O-RU RF |
| | components during the gaps). |

The above parameters in trxControl, TrxAntMask and Asm are shown in separate data structures as example. They can be combined and merged into O-NESPolicy without structuring and separation.

In another solution, E2 sservice management radio control (E2SM-RC) can be used for the control/policy types 1-6, which provide better latency and reliability than E2SM-CCC thanks to the underline transport mechanism, stream control transmission protocol (SCTP), and ASM encoding when used on E2SM-RC as compared to hypertext transfer protocol (HTTP) and JavaScript object notation (JSON) based protocol used on E2SM-CCC.

For control/policy type 1, the existing E2SM-RC features for traffic steering and QoS/QoE optimization can be used. For control/policy type 2, new control and policy service styles can be defined as listed in Table 7.

TABLE 7
Control and Policy Service Styles

| Control | Control | | Associated |
|---|---|---|---|
| Action | Action | Control Action | RAN |
| ID | Name | description | Parameters |
| 1 | Energy | To configure | See below |
| | Saving | parameters for | |
| | Configuration | energy saving | |
| Policy | Policy | Control Action | Associated |
| Action | Action Name | description | RAN |
| ID | | | Parameters |
| 1 | Energy Saving | To configure | See below |
| | Configuration | parameters for | |
| | | energy saving | |

The new RAN parameters of Table 8, below, can be defined and associated with the new control and policy service styles of Table 7.

TABLE 8
New RAN Parameters

| RAN | | RAN | | RAN |
|---|---|---|---|---|
| Parameter | RAN | Parameter | Key | Parameter |
| ID | Parameter | Value Type | Flag | Definition |
| | SSB Information | LIST | | TS 28.473, |
| | List | | | clause |
| | | | | 9.3.1.202 |
| | >SSB Information | STRUCTURE | | TS 28.473, |
| | Item | | | clause |
| | | | | 9.3.1.202 |
| | >SSB | STRUCTURE | | TS 28.473, |
| | Configuration | | | clause |
| | | | | 9.3.1.202 |

The parameters of the SSB Configuration may be as defined in Table 9.

TABLE 9
SSB Configuration Parameters

| | RAN | | RAN |
|---|---|---|---|
| | Parameter | Key | Parameter |
| Parameters | Value Type | Flag | Definition |
| SSB frequency | ELEMENT | | TS 28.473, clause |
| | | | 9.3.1.202 |
| SSB subcarrier spacing | ELEMENT | | TS 28.473, clause |
| | | | 9.3.1.202 |
| SSB Transmit power | ELEMENT | | TS 28.473, clause |
| | | | 9.3.1.202 |
| SSB periodicity | ELEMENT | | TS 28.473, clause |
| | | | 9.3.1.202 |
| SSB half frame index | ELEMENT | | TS 28.473, clause |
| | | | 9.3.1.202 |
| SSB SFN offset | ELEMENT | | TS 28.473, clause |
| | | | 9.3.1.202 |
| CHOICE SSB Position in | CHOICE | | TS 28.473, clause |
| Burst | | | 9.3.1.202 |
| >Short | STRUCTURE | | TS 28.473, clause |
| | | | 9.3.1.202 |
| >>Short Bitmap | ELEMENT | | TS 28.473, clause |
| | | | 9.3.1.202 |
| >Medium | STRUCTURE | | TS 28.473, clause |
| | | | 9.3.1.202 |
| >>Medium Bitmap | ELEMENT | | TS 28.473, clause |
| | | | 9.3.1.202 |
| >Long | STRUCTURE | | TS 28.473, clause |
| | | | 9.3.1.202 |
| >>Long Bitmap | ELEMENT | | TS 28.473, clause |
| | | | 9.3.1.202 |

The same E2SM-RC Control Message Format 1 can be used for this control with a new Control Header Format 4 as defined in Table 10.

TABLE 10
Control Header Format 4

| IE/ | | | IE type and | Semantics |
|---|---|---|---|---|
| Group Name | Presence | Range | reference | description |
| Cell Global ID | M | | 9.3.36 | Refer to O-RAN |
| | | | | Working Group 3, |
| | | | | Near-Real-time |
| | | | | RAN Intelligent |
| | | | | Controller, E2 Service |
| | | | | Model (E2SM). |
| NR PCI | O | | | Refer to TS28.541 |
| | | | | Clause 4.4.1, |
| | | | | ″nRPCI″ attribute |
| RIC Style Type | M | | 9.3.3 | |
| Control Action | M | | 9.3.6 | |
| ID | | | | |
| RIC Control | O | | ENUMERATED | |
| decision | | | (accept, | |
| | | | reject, ... ) | |

The same E2SM-RC Control Message Format 1 can be used for this control with a new Control Header Format 4 as defined in Table 10.

For control/policy type 3, new RAN parameters are shown in Table 11. The new RAN parameters may reuse Control Header Format 4 and Control Message Format 1.

TABLE 11
New RAN Parameters for Control/Policy Type 3

| | | RAN | | |
|---|---|---|---|---|
| RAN | | Parameter | | RAN |
| Parameter | RAN | Value | Key | Parameter |
| ID | Parameter | Type | Flag | Definition |
| | Energy saving | ELEMENT | | Specifies the status regarding the |
| | state ASM | | | energy saving in the cell. |
| | | | | If the value of |
| | | | | energySavingControl_ASM is |
| | | | | toBeEnergySaving, then it shall |
| | | | | be tried to achieve the value |
| | | | | isEnergySaving for the |
| | | | | energySavingState_ASM. |
| | | | | If the value of |
| | | | | energySavingControl_ASM is |
| | | | | toBeNotEnergySaving, then it |
| | | | | shall be tried to achieve the |
| | | | | value isNotEnergySaving for the |
| | | | | energySavingState_ASM. |
| | Energy saving | ELEMENT | | To initiate ASM optimization |
| | control ASM | | | activation or deactivation. |
| | Energy saving | ELEMENT | | Specifies the status regarding the |
| | state trxControl | | | energy saving in the cell. |
| | | | | If the value of |
| | | | | energySavingControl_trxControl |
| | | | | is toBeEnergySaving, then it |
| | | | | shall be tried to achieve the |
| | | | | value isEnergySaving for the |
| | | | | energySavingState_trxControl. |
| | | | | If the value of |
| | | | | energySavingControl_trxControl |
| | | | | is toBeNotEnergySaving, then it |
| | | | | shall be tried to achieve the |
| | | | | value isNotEnergySaving for the |
| | | | | energySavingState_trxControl. |
| | Energy saving | ELEMENT | | To initiate RF channel |
| | control | | | reconfiguration optimization |
| | trxControl | | | activation or deactivation. |
| | Energy saving | ELEMENT | | Each ES level implies a vendor- |
| | policy ASM | | | specific proprietary scheduling |
| | | | | algorithm that are not |
| | | | | standardized, for which each E2 |
| | | | | Node, who supports the ES |
| | | | | optimization feature, provides |
| | | | | the number of different policies |
| | | | | supported by its scheduler |
| | | | | indexed from 1 to n. The AI/ML |
| | | | | model for ES optimization is |
| | | | | trained by data and |
| | | | | measurements related to each ES |
| | | | | policy, for which the trained |
| | | | | AI/ML model, based on |
| | | | | collected data, configures the E2 |
| | | | | Node with an improved inferred |
| | | | | policy index to be used. The |
| | | | | Value = 0 means no ES |
| | | | | optimization (maximum |
| | | | | performance) where higher |
| | | | | index value may means more |
| | | | | aggressive ES optimization |
| | | | | depends on vendor specific |
| | | | | implementation. |
| | Energy saving | ELEMENT | | Each ES level implies a vendor- |
| | policy trxControl | | | specific proprietary scheduling |
| | | | | algorithm that are not |
| | | | | standardized, for which each E2 |
| | | | | Node, who supports the ES |
| | | | | optimization feature, provides |
| | | | | the number of different policies |
| | | | | supported by its scheduler |
| | | | | indexed from 1 to n. The AI/ML |
| | | | | model for ES optimization is |
| | | | | trained by data and |
| | | | | measurements related to each ES |
| | | | | policy, for which the trained |
| | | | | AI/ML model, based on |
| | | | | collected data, configures the E2 |
| | | | | Node with an improved inferred |
| | | | | policy index to be used. The |
| | | | | Value = 0 means no ES |
| | | | | optimization (maximum |
| | | | | performance) where higher |
| | | | | index value may means more |
| | | | | aggressive ES optimization |
| | | | | depends on vendor specific |
| | | | | implementation. |

For control/policy type 4-6, new RAN parameters can be introduced as shown in Table 12 and reuse Control Header Format 4 and Control Message Format 1.

TABLE 12
New RAN Parameters for Control/Policy Types 4 and 5

| RAN | | RAN | | RAN |
|---|---|---|---|---|
| Parameter | RAN | Parameter | Key | Parameter |
| ID | Parameter | Value Type | Flag | Definition |
| | Trx Control | STRUCTURE | | This command is defined |
| | | | | to configure O-DU to |
| | | | | energy saving mode by |
| | | | | disabling (″putting to |
| | | | | sleep″) some or all array |
| | | | | elements in a tx-array or |
| | | | | rx-array (or both). In the |
| | | | | command an antenna |
| | | | | mask is provided to |
| | | | | indicate which array |
| | | | | elements are to be put to |
| | | | | sleep or woken up. |
| | Trx Antenna Mask | STRUCTURE | | This command is to |
| | | | | provide predefined |
| | | | | antenna masks to the O- |
| | | | | DU to define which array |
| | | | | elements are to be |
| | | | | disabled during the sleep |
| | | | | period decided by the O- |
| | | | | DU itself. |
| | Asm | STRUCTURE | | This command is defined |
| | | | | to configure O-DU to |
| | | | | energy saving mode by |
| | | | | disabling (″putting to |
| | | | | sleep″) array carriers, tx- |
| | | | | arrays or rx-arrays or the |
| | | | | whole O-RU. When the |
| | | | | command is issued it |
| | | | | pertains to all array |
| | | | | elements in the affected |
| | | | | tx-array or rx-array. |

The definition of the RAN parameters Trx Control, Trx Antenna Mask and Asm may be as defined previously. The parameters may be separated into trxControl, TrxAntMask and Asm as example. They can be combined and merged into Control Message Format 1 without structuring and separation.

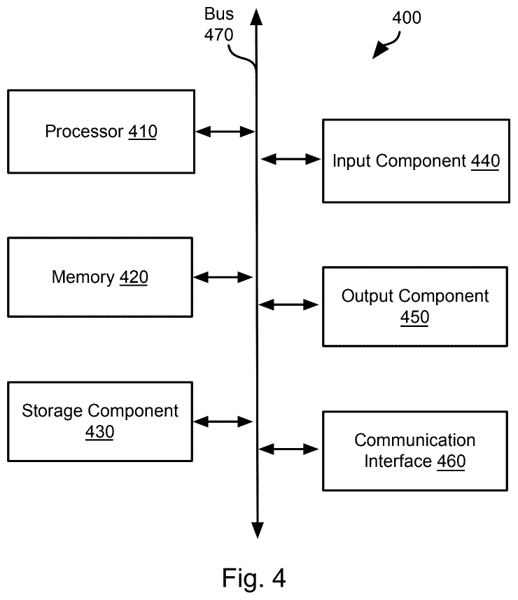

FIG. 4 illustrates an embodiment of a device 400. As shown in FIG. 4, the device 400 processor 410, a memory 420, a storage component 430, an input component 440, an output component 450, a communication interface 460, and a bus 470.

The processor 410, as used herein, means any type of computational circuit that may comprise hardware elements and software elements. The processor 410 may be embodied as a multi-core processor, a single core processor, or a combination of one or more multi-core processors and/or one or more single core processors, a distributed processing system, or the like. The processor 410 may be a Central Processing Unit (CPU) a graphics processing unit (GPU), an accelerated processing unit (APU), an application-specific integrated circuit (ASIC), or another type of processing component.

Memory 420 includes a non-transitory computer readable medium. Memory 420 includes a random-access memory (RAM), a read only memory (ROM), and/or another type of dynamic or static storage device (e.g., a flash memory, a magnetic memory, and/or an optical memory) that stores information and/or instructions for use by processor 410. The memory 420 comprises machine-readable instructions which are executable by the processor 410. These machine-readable instructions when executed by the processor 410 cause the processor 410 to perform one or more method steps of an embodiment described above.

Storage component 430 stores information and/or software related to the operation and use of the device 400. For example, storage component 430 may include a hard disk (e.g., a magnetic disk, an optical disk, a magneto-optic disk, and/or a solid-state disk), a compact disc (CD), a digital versatile disc (DVD), a floppy disk, a cartridge, a magnetic tape, and/or another type of non-transitory computer-readable medium, along with a corresponding drive.

Input component 440 is configured to receive information, such as user input. For example, the input component 440 may include, but not be limited to, a touch screen display, a keyboard, a keypad, a mouse, a button, a switch, and/or a microphone. Additionally, or alternatively, the input component 440 may include a sensor for sensing information (e.g., a global positioning system (GPS), an accelerometer, a gyroscope, and/or an actuator).

Output component 450 is configured to provide output information from the device 400. For example, the output component 450 may be, but not limited to, a display, a speaker, instructions to an external device, and/or one or more light-emitting diodes (LEDs).

Communication interface 460 is an interface that provides a communication connection to other devices, such as external devices and internal devices. The connection by the communication interface 460 can be a wired connection, a wireless connection, or a combination of wired and wireless connections, and can be a direct connection or an indirect connection via a communication network that exists between the device 400 and other devices. In other words, the standard of the communication interface 460 is not limited.

The bus 470 acts as an interconnect between the processor 410, the memory 420, the storage component 430, the input component 440, the output component 450, and the communication interface 460 of the device 400. The bus 470 may include a wired interconnection or a wireless interconnection.

The number and arrangement of components shown in FIG. 4 are provided as an example. In practice, device 400 may include additional components, fewer components, different components, or differently arranged components than those shown in FIG. 4. Additionally, or alternatively, a set of components (e.g., one or more components) of device 400 may perform one or more functions described as being performed by another set of components of device 400. Further, one or more method steps described in any of the embodiments may be performed utilizing a plurality of devices 400 in communication with one another.

### EXAMPLE EMBODIMENTS

Example Embodiment 1. A cellular communication network comprising:
a plurality of antennas;
a plurality of radio units coupled to the plurality of antennas and configured to input analog signals to the plurality of antennas;
one or more distributed units coupled to the plurality of radio units and configured to control operation of the plurality of radio units;
one or more central units coupled to the one or more distributed units; and
a near real time radio access network (RAN) intelligent controller (RIC) coupled to at least one of the one or more distributed units or the one or more central units by way of one or more E2 interfaces, the near real time RIC configured to invoke execution or enforcement of energy saving controls or policies by the at least one of the one or more distributed units or the one or more central units over the one or more E2 interfaces.

Example Embodiment 2. The cellular communication network of Example Embodiment 1, wherein the near real time RIC is configured to:
analyze traffic through the plurality of radio units using at least one of a machine learning model and an artificial intelligence model; and
configure the at least one of the one or more distributed units or one or more central units according to the traffic according to an output of the at least one of the machine learning model and the artificial intelligence model.

Example Embodiment 3. The cellular communication network of Example Embodiment 1, wherein the one or more central units are configured to handle Evolved Universal Mobile Telecommunications System (UMTS) Terrestrial Radio Access New Radio Network (E-UTRAN-NR) dual connectivity, carrier aggregation, connected mode mobility, idle mode mobility and radio access controls to steering user equipment (UE) traffic from a cell to another cell in order to create more sleeping opportunities for the cell while maintaining acceptable quality of service (QoS) for UEs potentially being affected.

Example Embodiment 4. The cellular communication network of Example Embodiment 1, wherein the one or more central units are configured to handle cell and UE discontinuous transmission (DTX) and discontinuous reception (DRX) configurations as well as common channel configurations to create more deep sleep opportunities.

Example Embodiment 5. The cellular communication network of Example Embodiment 1, wherein the one or more distributed units are configured to adjust a scheduling policy and scheduling behavior according to the energy saving controls or policies.

Example Embodiment 6. The cellular communication network of Example Embodiment 5, wherein the one or more distributed units are configured to adjust the scheduling policy by selecting from a plurality of predefined energy saving scheduling policies according to an output of at least one of a machine learning model and an artificial intelligence model.

Example Embodiment 7. The cellular communication network of Example Embodiment 5, wherein the near real time RIC is configured to guide at least a portion of the one or more distributed units to configure one or more open radio access network radio unit (O-RU) radio frequency (RF) channels of a carrier or cell or the entire carrier or cell into sleep mode via open radio access network front haul control plane (O-FH C-plane) or management (M)-plane for certain slots or symbols following a periodic pattern, or for a continuous sleep interval.

Example Embodiment 8. The cellular communication network of Example Embodiment 5, wherein the near real time RIC is configured to guide the one or more distributed units with configuration of array patterns, multiple input multiple output (MIMO) layers, and precoding matrixes for improved energy efficiency and service coverage and performance during sleep periods.

Example Embodiment 9. The cellular communication network of Example Embodiment 5, wherein the one or more distributed units are configured with performance and energy efficiency or energy consumption targets for cells, carrier, each radio unit of the plurality of radio units, and geographic area.

Example Embodiment 10. A method for saving energy in a cellular communication network, the method comprising:
receiving, by a near real time radio access network (RAN) intelligent controller (RIC), traffic data for a cellular communication network including:
a plurality of antennas;
a plurality of radio units coupled to the plurality of antennas and configured to input analog signals to the plurality of antennas;
one or more distributed units coupled to the plurality of radio units and configured to control operation of the plurality of radio units; and
one or more central units coupled to the one or more distributed units; and
configuring, by the near real time RIC, at least one of the one or more distributed units or the one or more central units over one or more E2 interfaces to execute or enforce energy saving controls or policies.

Example Embodiment 11. The method of Example Embodiment 10, wherein the near real time RIC is configured to analyze the traffic data using at least one of a machine learning model and an artificial intelligence model and determine the energy saving controls or policies according to an output of the at least one of the machine learning model and the artificial intelligence model.

Example Embodiment 12. The method of Example Embodiment 10, wherein the one or more central units are configured to handle Evolved Universal Mobile Telecommunications System (UMTS) Terrestrial Radio Access New Radio Network (E-UTRAN-NR) dual connectivity, carrier aggregation, connected mode mobility, idle mode mobility and radio access controls to steering user equipment (UE) traffic from a cell to another cell in order to create more sleeping opportunities for the cell while maintaining acceptable quality of service (QoS) for UEs potentially being affected.

Example Embodiment 13. The method of Example Embodiment 10, wherein the one or more central units are configured to handle cell and UE discontinuous transmission (DTX) and discontinuous reception (DRX) configurations and common channel configurations to create more deep sleep opportunities.

Example Embodiment 14. The method of Example Embodiment 10, wherein the one or more distributed units are configured to adjust a scheduling policy and scheduling behavior according to the energy saving controls or policies.

Example Embodiment 15. The method of Example Embodiment 10, further comprising adjusting, by the one or more distributed units, a scheduling policy and a scheduling behavior by selecting from a plurality of predefined energy saving scheduling policies according to an output of a machine learning model.

Example Embodiment 16. The method of Example Embodiment 10, wherein the near real time RIC is configured to guide at least a portion of the one or more distributed units to configure certain open radio access network radio unit (O-RU) radio frequency (RF) channels of a carrier or cell or the entire carrier or cell into sleep mode via open radio access network front haul control plane (O-FH C-plane) or management (M)-plane for certain slots or symbols following a periodic pattern, or for a continuous sleep interval.

Example Embodiment 17. The method of Example Embodiment 10, wherein the near real time RIC is configured to guide the one or more distributed units with configuration of array patterns, multiple input multiple output (MIMO) layers, and precoding matrixes for improved energy efficiency and service coverage and performance during sleep periods.

Example Embodiment 18. The method of Example Embodiment 10, further comprising configuring, by the near real time RIC, the one or more distributed units with performance and energy efficiency or energy consumption targets for cells, each radio unit of the plurality of radio units, and geographic area.

Example Embodiment 19. A non-transitory computer readable medium storing executable code configured to execute in a cellular communication network comprising:
a plurality of antennas;
a plurality of radio units coupled to the plurality of antennas and configured to input analog signals to the plurality of antennas;
one or more distributed units coupled to the plurality of radio units and configured to control operation of the plurality of radio units; and
a near real time radio access network (RAN) intelligent controller (RIC) coupled to the one or more distributed units by way of one or more E2 interfaces;
wherein the executable code, when executed by the near real time RIC, causes the near real time RIC to invoke implementation of energy saving policies by the one or more distributed units over the one or more E2 interfaces.

1. A cellular communication network comprising:
a plurality of antennas;
a plurality of radio units coupled to the plurality of antennas and configured to input analog signals to the plurality of antennas;
one or more distributed units coupled to the plurality of radio units and configured to control operation of the plurality of radio units;
one or more central units coupled to the one or more distributed units; and
a near real time radio access network (RAN) intelligent controller (RIC) coupled to at least one of the one or more distributed units or the one or more central units by way of one or more E2 interfaces, the near real time RIC configured to invoke execution or enforcement of energy saving controls or policies by the at least one of the one or more distributed units or the one or more central units over the one or more E2 interfaces.

2. The cellular communication network of claim 1, wherein the near real time RIC is configured to:
analyze traffic through the plurality of radio units using at least one of a machine learning model and an artificial intelligence model; and
configure the at least one of the one or more distributed units or one or more central units according to the traffic according to an output of the at least one of the machine learning model and the artificial intelligence model.

3. The cellular communication network of claim 1, wherein the one or more central units are configured to handle Evolved Universal Mobile Telecommunications System (UMTS) Terrestrial Radio Access New Radio Network (E-UTRAN-NR) dual connectivity, carrier aggregation, connected mode mobility, idle mode mobility and radio access controls to steering user equipment (UE) traffic from a cell to another cell in order to create more sleeping opportunities for the cell while maintaining acceptable quality of service (QoS) for UEs potentially being affected.

4. The cellular communication network of claim 1, wherein the one or more central units are configured to handle cell and UE discontinuous transmission (DTX) and discontinuous reception (DRX) configurations as well as common channel configurations to create more deep sleep opportunities.

5. The cellular communication network of claim 1, wherein the one or more distributed units are configured to adjust a scheduling policy and scheduling behavior according to the energy saving controls or policies.

6. The cellular communication network of claim 5, wherein the one or more distributed units are configured to adjust the scheduling policy by selecting from a plurality of predefined energy saving scheduling policies according to an output of at least one of a machine learning model and an artificial intelligence model.

7. The cellular communication network of claim 5, wherein the near real time RIC is configured to guide at least a portion of the one or more distributed units to configure one or more open radio access network radio unit (O-RU) radio frequency (RF) channels of a carrier or cell or the entire carrier or cell into sleep mode via open radio access network front haul control plane (O-FH C-plane) or management (M)-plane for certain slots or symbols following a periodic pattern, or for a continuous sleep interval.

8. The cellular communication network of claim 5, wherein the near real time RIC is configured to guide the one or more distributed units with configuration of array patterns, multiple input multiple output (MIMO) layers, and precoding matrixes for improved energy efficiency and service coverage and performance during sleep periods.

9. The cellular communication network of claim 5, wherein the one or more distributed units are configured with performance and energy efficiency or energy consumption targets for cells, carrier, each radio unit of the plurality of radio units, and geographic area.

10. A method for saving energy in a cellular communication network, the method comprising:
receiving, by a near real time radio access network (RAN) intelligent controller (RIC), traffic data for a cellular communication network including:
a plurality of antennas;
a plurality of radio units coupled to the plurality of antennas and configured to input analog signals to the plurality of antennas;
one or more distributed units coupled to the plurality of radio units and configured to control operation of the plurality of radio units; and
one or more central units coupled to the one or more distributed units; and
configuring, by the near real time RIC, at least one of the one or more distributed units or the one or more central units over one or more E2 interfaces to execute or enforce energy saving controls or policies.

11. The method of claim 10, wherein the near real time RIC is configured to analyze the traffic data using at least one of a machine learning model and an artificial intelligence model and determine the energy saving controls or policies according to an output of the at least one of the machine learning model and the artificial intelligence model.

12. The method of claim 10, wherein the one or more central units are configured to handle Evolved Universal Mobile Telecommunications System (UMTS) Terrestrial Radio Access New Radio Network (E-UTRAN-NR) dual connectivity, carrier aggregation, connected mode mobility, idle mode mobility and radio access controls to steering user equipment (UE) traffic from a cell to another cell in order to create more sleeping opportunities for the cell while maintaining acceptable quality of service (QoS) for UEs potentially being affected.

13. The method of claim 10, wherein the one or more central units are configured to handle cell and UE discontinuous transmission (DTX) and discontinuous reception (DRX) configurations and common channel configurations to create more deep sleep opportunities.

14. The method of claim 10, wherein the one or more distributed units are configured to adjust a scheduling policy and scheduling behavior according to the energy saving controls or policies.

15. The method of claim 10, further comprising adjusting, by the one or more distributed units, a scheduling policy and a scheduling behavior by selecting from a plurality of predefined energy saving scheduling policies according to an output of a machine learning model.

16. The method of claim 10, wherein the near real time RIC is configured to guide at least a portion of the one or more distributed units to configure certain open radio access network radio unit (O-RU) radio frequency (RF) channels of a carrier or cell or the entire carrier or cell into sleep mode via open radio access network front haul control plane (O-FH C-plane) or management (M)-plane for certain slots or symbols following a periodic pattern, or for a continuous sleep interval.

17. The method of claim 10, wherein the near real time RIC is configured to guide the one or more distributed units with configuration of array patterns, multiple input multiple output (MIMO) layers, and precoding matrixes for improved energy efficiency and service coverage and performance during sleep periods.

18. The method of claim 10, further comprising configuring, by the near real time RIC, the one or more distributed units with performance and energy efficiency or energy consumption targets for cells, each radio unit of the plurality of radio units, and geographic area.

19. A non-transitory computer readable medium storing executable code configured to execute in a cellular communication network comprising:
a plurality of antennas;
a plurality of radio units coupled to the plurality of antennas and configured to input analog signals to the plurality of antennas;
one or more distributed units coupled to the plurality of radio units and configured to control operation of the plurality of radio units; and
a near real time radio access network (RAN) intelligent controller (RIC) coupled to the one or more distributed units by way of one or more E2 interfaces;
wherein the executable code, when executed by the near real time RIC, causes the near real time RIC to invoke implementation of energy saving policies by the one or more distributed units over the one or more E2 interfaces.
